(19) United States
(12) Patent Application Publication
(10) Pub. No.: US 2011/0318554 A1
(43) Pub. Date: Dec. 29, 2011

(54) HYPERBRANCHED POLYMER CONTAINING THIOESTER GROUPS

(75) Inventors: Hideo Nagashima, Fukuoka-shi (JP); Shiyoshi Yokoyama, Fukuoka-shi (JP); Shin-ichiro Inoue, Fukuoka-shi (JP); Azusa Inoue, Fukuoka-shi (JP); Keisuke Kojima, Funabashi-shi (JP)

(73) Assignees: NISSAN CHEMICAL INDUSTRIES, LTD., TOKYO (JP); KYUSHU UNIVERSITY, FUKUOKA-SHI, FUKUOKA (JP)

(21) Appl. No.: 13/146,556

(22) PCT Filed: Jan. 27, 2010
(86) PCT No.: PCT/JP2010/051064

§ 371 Date: Sep. 9, 2011

(30) Foreign Application Priority Data
Jan. 27, 2009 (JP) 2009-016050

(51) Int. Cl. B32B 7/02; C09D 125/06; G02B 5/22; C08F 8/34

(52) U.S. Cl. 428/212; 525/123; 524/576; 252/589

(57) ABSTRACT

There is provided a polymer having a high refractive index without forming a complex with inorganic fine particles, being excellent in the solubility in an organic solvent and the coating properties during film formation, and having a high transparency, and further being capable of dispersing optically homogeneously a functional dye such as a nonlinear dye in a high concentration. A hyperbranched polymer containing a thioester group of Formula (1) below [where R¹ is a hydrogen atom or a methyl group; Ar¹ and Ar² are independently an aromatic ring group constituted of 5 to 18 ring atoms that is optionally substituted with a C₁₋₆ alkyl group, a C₁₋₆ alkoxy group, a C₁₋₆ alkylthio group, or a halogen atom, the aromatic ring group optionally contains a hetero atom, or is optionally an aromatic ring group formed by two or more fused rings; A′ is a structure of Formula (2) or Formula (3) below; and n is the number of repeating unit structures and is an integer of 2 to 100,000].

[symbol]

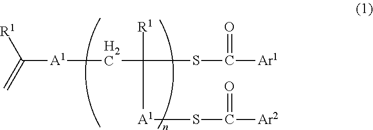

[symbol]

### TECHNICAL FIELD

The present invention relates to a hyperbranched polymer containing a thioester group and various opto devices using the polymer.

### BACKGROUND ART

Conventionally, inorganic dielectric materials, inorganic nonlinear optical materials, and other materials used for various optical elements have been commercialized and widely used.

For example, there are disclosed dielectric multilayer films (Patent Document 1 and Patent Document 2) produced by alternately laminating a layer formed with a metal compound having a high refractive index such as TiO₂, Ta₂O₅, and ZrO₂ and a layer formed with a metal compound having a low refractive index such as MgF₂ and SiO₂, and inorganic nonlinear materials using lithium niobate, potassium dihydrogen phosphate, and the like. In order to utilize these inorganic materials as various elements, it becomes necessary, for example, to form the above inorganic compound into a film by a vapor deposition method, a sputtering method, or other methods and further to form a laminate. However, there remain problems in productivity and production cost such as a problem that for forming a film, a vacuum environment is necessary and a vapor deposition source corresponding to each compound becomes necessary, so that the production process becomes complex, and a problem that the production apparatus becomes upsized.

In recent years, in contrast to these inorganic materials, there are attracting attention organic optical materials having superiorities such as high optical performance, low material cost, and high mass productivity, and vigorous research and development for the commercialization of these organic optical materials is performed. Particularly, polymer-based organic materials can be formed into a film by a casting method, a dipping method, a spin coating method, or other methods, so that such a term that the polymer-based organic material can be easily processed into various elements is attracting attention.

For example, in the field of organic dielectric multilayer film, there are proposed polymer optical multilayer films utilizing two types of polymers having different refractive indexes (Patent Document 3), high refractive index hybrid materials in which a high refractive index inorganic dielectric is dispersed in a polymer matrix, high refractive index materials in which a large amount of bromine atoms or sulfur atoms is introduced, dithiocarbamate group-containing hyperbranched polymers exhibiting a high refractive index, and the like.

In the field of organic nonlinear optical materials, a method for dispersing a compound having nonlinear optical characteristics in a polymer matrix and other methods are proposed and, for example, there are reported a material in which Disperse Red 1 (DR 1) having a diethylamino group that is an electron-donating group and a nitro group that is an electron-withdrawing group in azobenzene as a π conjugate chain and the like are dispersed in polymethyl methacrylate (PMMA) or the like and a material using a polymer having a high glass transition temperature such as a polycarbonate, a polyimide, and a polysulfon as an alternative to PMMA (see Patent Document 4).

### RELATED-ART DOCUMENT

### Patent Document

Patent Document 1: Japanese Patent Application Publication No. JP-A-11-305014

Patent Document 2: Japanese Patent Application Publication No. JP-A-2003-107223

Patent Document 3: Japanese Patent Application Publication No. JP-A-2005-55543

Patent Document 4: Japanese Patent Application Publication No. JP-A-6-202177

### Non-Patent Document

Non-patent Document 1: Koji Ishizu, Akihide Mori, Polymer International 50, 906-910 (2001)

Non-patent Document 2: Koji Ishizu, Takeshi Shibuya, Akihide Mori, Polymer International 51, 424-428 (2002)

Non-patent Document 3: Koji Ishizu, Yoshihiro Ohta, Journal of Materials Science Letters, 22 (9), 647-650 (2003)

Non-patent Document 4: Roussey, M., Bernal, M.-P., Courjal, N., Labeke, D. V. and Baida, F. I. and Salut, R, “Electro-optic effect exaltation on lithium niobate photonic crystals due to slow photons,” Appl. Phys. Lett. 89, 241110-1-3 (2006).

Non-patent Document 5: Koji Ishizu, Akihide Mori, Macromol. Rapid Commun. 21, 665-668 (2000)

### DISCLOSURE OF THE INVENTION

### Problem To Be Solved By the Invention

With respect to the organic dielectric multilayer film, there are problems such as a problem that when a conventional linear polymer is used, the solubility and the coating properties are poor, and during film formation, the removal (evaporation) of a solvent takes much time, and a problem that in a system in which an inorganic dielectric is dispersed, a usable solvent is limited and dispersed inorganic fine particles (dielectric) are secondary aggregated. When a bromine atom or a sulfur atom is introduced into the polymer, the stability and the transparency of the film is problematic and the solubility of the polymer in an organic solvent lowers. When a dithiocarbamate group is introduced into the polymer, the polymer is radical-cleaved by light or heat, so that there is a problem that the application of the polymer is limited.

With respect to the organic nonlinear optical material described above, the compatibility of a polymer matrix (such as PMMA) with a compound (dye molecule) having nonlinear optical characteristics is problematic, and when for enhancing the nonlinear optical characteristics, dye molecules are blended in a high concentration, there is a problem that the dye molecules are aggregated or crystallized, or even when the dye molecules are blended in a low concentration, there is a problem that by heating or with time, the aggregation or the crystallization is caused.

The present invention has been made by taking the above-mentioned status into account, and it is an object of the present invention to provide a polymer having a high refractive index without forming a complex with inorganic fine particles, being excellent in the solubility in an organic solvent and the coating properties during film formation, and having a high transparency, and further being capable of dispersing optically homogeneously a functional dye such as a nonlinear dye in a high concentration.

### Means For Solving the Problem

As a result of assiduous research intended to achieve the above object, the inventors of the present invention have found that a hyperbranched polymer in which a dithiocarbamate group is replaced by a thioester group is a polymer containing all of the above functions, and have completed the present invention.

That is, the present invention, according to a first aspect, relates to a hyperbranched polymer containing a thioester group of Formula (1):

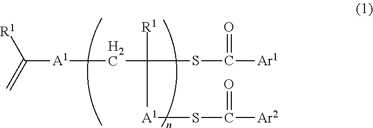

[where R¹ is a hydrogen atom or a methyl group;
Ar' and Ar² are independently an aromatic ring group constituted of 5 to 18 ring atoms that is optionally substituted with a C₁₋₆ alkyl group, a C₁₋₆ alkoxy group, a C₁₋₆ alkylthio group, or a halogen atom;
A¹ is a structure of Formula (2) or Formula (3) below; and
n is the number of repeating unit structures and is an integer of 2 to 100,000]:

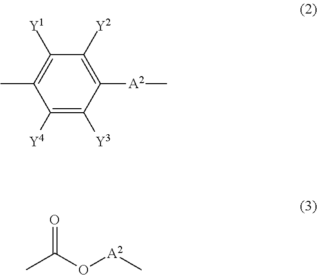

[in Formula (2) and Formula (3), A² is a linear C₁₋₃₀ alkylene group that optionally contains an ether bond or an ester bond, or a branched or cyclic C₃₋₃₀ alkylene group that optionally contains an ether bond or an ester bond; and
Y¹, Y², Y³, and Y⁴ are independently a hydrogen atom, a C₁₋₂₀ alkyl group, a C₁₋₂₀ alkoxy group, a halogen atom, a nitro group, a hydroxy group, an amino group, a carboxy group, or a cyano group].

According to a second aspect, the present invention relates to the hyperbranched polymer containing a thioester group as described in the first aspect, in which A¹ is a structure of Formula (4):

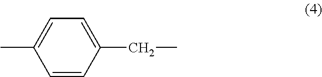

According to a third aspect, the present invention relates to the hyperbranched polymer containing a thioester group as described in the first aspect or the second aspect, in which at least one of Ar¹ and Ar² is a structure of Formula (5):

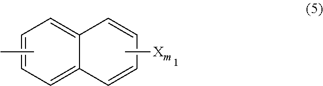

[where X is a C₁₋₆ alkyl group, a C₁₋₆ alkylthio group, or a halogen atom; and
m₁ is the number of added Xs and is an integer of 0 to 7].

According to a fourth aspect, the present invention relates to the hyperbranched polymer containing a thioester group as described in the first aspect or the second aspect, in which at least one of Ar¹ and Ar² is a structure of Formula (6):

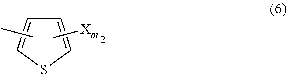

[where X is a C₁₋₆ alkyl group, a C₁₋₆ alkylthio group, or a halogen atom; and
m₂ is the number of added Xs and is an integer of 0 to 3].

According to a fifth aspect, the present invention relates to a varnish produced by dissolving or dispersing the hyperbranched polymer containing a thioester group as described in any one of the first aspect to the fourth aspect in at least one type of solvent.

According to a sixth aspect, the present invention relates to a thin film produced from the varnish as described in the fifth aspect.

According to a seventh aspect, the present invention relates to a polymer multilayer film produced by using the thin film as described in the sixth aspect.

According to an eighth aspect, the present invention relates to a polymer multilayer film mirror produced by alternately laminating a high refractive index film containing the thin film as described in the sixth aspect and a low refractive index film having a refractive index lower than a refractive index of the high refractive index film on a substrate.

According to a ninth aspect, the present invention relates to a functional dye dispersant containing the hyperbranched polymer containing a thioester group as described in any one of the first aspect to the fourth aspect.

According to a tenth aspect, the present invention relates to a nonlinear optical material produced by dispersing a functional dye in the hyperbranched polymer containing a thioester group as described in any one of the first aspect to the fourth aspect.

### Effects of the Invention

The hyperbranched polymer containing a thioester group of the present invention is a polymer having a high refractive index and high transparency, and the hyperbranched polymer has a thioester group as a terminal group, so that during the preservation of the polymer or the use of the polymer, there is caused no decomposition and the like in the polymer by light, heat, or the like, and the hyperbranched polymer is a polymer with high stability.

The hyperbranched polymer containing a thioester group of the present invention has high solubility and high dispersibility in a solvent, and even when the polymer concentration is high, the solution has a low viscosity, so that the hyperbranched polymer can be easily made into a form of a varnish of polymer to be used in the preparation of various materials.

Moreover, in the case where the hyperbranched polymer containing a thioester group of the present invention is used as a polymer matrix, when various guest materials, for example various functional dyes, are blended therein in a high concentration, the hyperbranched polymer can homogeneously disperse these guest materials therein without aggregating the guest materials.

A varnish containing the hyperbranched polymer containing a thioester group of the present invention has a viscosity lower than that of a varnish using a linear polymer having the same average molecular weight as that of the hyperbranched polymer, so that the varnish is excellent in coating properties and can easily form a thin film by a spin coating method or other methods. Moreover, the varnish of the present invention can easily remove (evaporate) a solvent during the formation of the thin film and can obtain such an effect as capable of being suitably used as an optical material having high handling properties.

Further, a thin film formed from the varnish of the present invention has a high refractive index and high transparency, so that the thin film can be used as a film used for polymer multilayer films and various optical materials such as a nonlinear optical material.

### BRIEF DESCRIPTION OF THE DRAWINGS

FIG. 1 is a graph showing a ¹H NMR spectrum of the branched polymer (HPS) containing a dithiocarbamate group prepared in Reference Example 1.

FIG. 2 is a graph showing a ¹H NMR spectrum of the hyperbranched polymer having a 2-naphthoylthio group prepared in Example 1.

FIG. 3 is a graph showing a ¹H NMR spectrum of the hyperbranched polymer having a 2-thenoylthio group prepared in Example 2.

FIG. 4 is a graph showing a measurement result (in terms of absorption coefficient) of a UV spectrum of the thin film obtained in Example 4.

FIG. 5 is a schematic view showing a poling apparatus used for a poling test used in Example 5.

FIG. 6 is a schematic view showing the polymer multilayer film mirror prepared in Example 6.

FIG. 7 is a graph showing transmission spectra of the polymer multilayer film mirrors (of 1, 3, 5, 9, and 17 layer(s)) obtained in Example 6.

FIG. 8 is a graph showing a transmission spectrum of the polymer multilayer film mirror (of 17 layers) obtained in Example 6 and a theoretical curve calculated by a transfer matrix method.

FIG. 9 is a schematic view showing a model figure of a polymer multilayer film in which a defect layer is provided in a one-dimensional periodic structure.

FIG. 10 is a graph showing theoretical curves of a normalized electric field strength and a refractive index relative to a layer thickness (z) that are calculated by a transfer matrix method.

FIG. 11 is a graph showing a ¹H NMR spectrum of the hyperbranched polymer having a 2-naphthoylthio group prepared in Example 7.

FIG. 12 is a graph showing a ¹H NMR spectrum of the hyperbranched polymer having a 2-naphthoylthio group prepared in Example 8.

FIG. 13 is a graph showing a ¹H NMR spectrum of the hyperbranched polymer having a 2-naphthoylthio group prepared in Example 9.

FIG. 14 is a graph showing a ¹H NMR spectrum of the hyperbranched polymer having a 2-thenoylthio group prepared in Example 10.

### BEST MODES FOR CARRYING OUT THE INVENTION

### Hyperbranched Polymer Containing Thioester Group

The present invention relates to a hyperbranched polymer containing a thioester group of Formula (1):

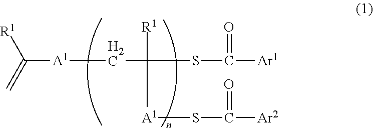

[where R¹ is a hydrogen atom or a methyl group;
Ar¹ and Ar² are independently an aromatic ring group constituted of 5 to 18 ring atoms that may be substituted with a C₁₋₆ alkyl group, a C₁₋₆ alkoxy group, a C₁₋₆ alkylthio group, or a halogen atom;
A¹ is a structure of Formula (2) or Formula (3); and
n is the number of repeating unit structures and is an integer of 2 to 100,000].

With respect to Ar¹ and Ar², the aromatic ring group constituted of 5 to 18 ring atoms is an aromatic ring group containing 5 to 18 atoms, and the aromatic ring group may contain hetero atoms and/or may be formed by the condensation of two or more rings. Examples of the aromatic ring in such an aromatic ring group include benzene, naphthalene, anthracene, phenanthrene, fluorene, tetracene, tetraphene, triphenylene, pyrene, furan, thiophene, benzothiophene, thienothiophene, benzodithiophene, dithienothiophene, benzodithienothiophene, naphthodithiophene, pyridine, indole, quinoline, and carbazole.

Examples of the C₁₋₆ alkyl group as a substituent of the aromatic ring group include a methyl group, an ethyl group, an n-propyl group, an isopropyl group, an n-butyl group, an isobutyl group, a sec-butyl group, a tert-butyl group, an n-pentyl group, an isopentyl group, a neopentyl group, a tert-pentyl group, a cyclopentyl group, an n-hexyl group, and a cyclohexyl group.

Examples of the C₁₋₆ alkoxy group as a substituent of the aromatic ring group include a methoxy group, an ethoxy group, an n-propoxy group, an isopropoxy group, an n-butoxy group, an isobutoxy group, a sec-butoxy group, and a tert-butoxy group.

Examples of the C₁₋₆ alkylthio group as a substituent of the aromatic ring group include a methylthio group, an ethylthio group, an n-propylthio group, an isopropylthio group, an n-butylthio group, an isobutylthio group, a sec-butylthio group, a tert-butylthio group, an n-pentylthio group, an isopentylthio group, a neopentylthio group, a tert-pentylthio group, an n-hexylthio group, and an isohexylthio group.

Examples of the halogen atom include a fluorine atom, a chlorine atom, a bromine atom, and an iodine atom, and preferred are a bromine atom and an iodine atom.

Particularly preferred examples of Ar¹ and Ar² include structures of Formula (5) below or Formula (6) below.

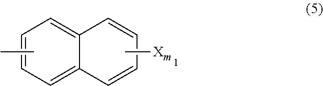

[where X is a C₁₋₆ alkyl group, a C₁₋₆ alkylthio group, or a halogen atom, and m₁ is the number of added Xs and is an integer of 0 to 7].

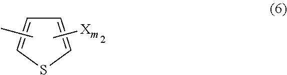

[where X is a C₁₋₆ alkyl group, a C₁₋₆ alkylthio group, or a halogen atom, and m₂ is the number of added Xs and is an integer of 0 to 3].

The C₁₋₆ alkyl group, the C₁₋₆ alkylthio group, and the halogen atom are the same as those defined with respect to Ar¹ and Ar² in Formula (1).

Preferably, Ar¹ and Ar² are a structure of Formula (5) or Formula (6) in which m₁ and m₂ are 0.

In Formula (1), A¹ is a structure of Formula (2) or Formula (3):

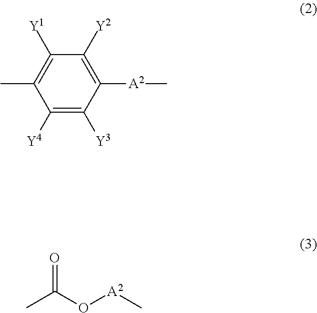

[in Formula (2) and Formula (3), A² is a linear C₁₋₃₀ alkylene group that may contain an ether bond or an ester bond, or a branched or cyclic C₃₋₃₀ alkylene group that may contain an ether bond or an ester bond; and
Y¹, Y², Y³, Y and Y⁴ are independently a hydrogen atom, a C₁₋₂₀ alkyl group, a C₁₋₂₀ alkoxy group, a halogen atom, a nitro group, a hydroxy group, an amino group, a carboxy group, or a cyano group].

Specific examples of the linear alkylene group include a methylene group, an ethylene group, an n-propylene group, an n-butylene group, and an n-hexylene group.

Specific examples of the branched alkylene group include an isopropylene group, an isobutylene group, and a 2-methylpropylene group.

Examples of the cyclic alkylene group include monocycle-, multicycle-, or crosslinked cycle-structural C₃₋₃₀ alicyclic aliphatic groups, and specific examples thereof include groups having a monocyclo, bicyclo, tricyclo, tetracyclo, or pentacyclo C_{4 or more} structure. Structural examples (a) to (s) of the alicyclic moiety of the alicyclic aliphatic group are shown below.

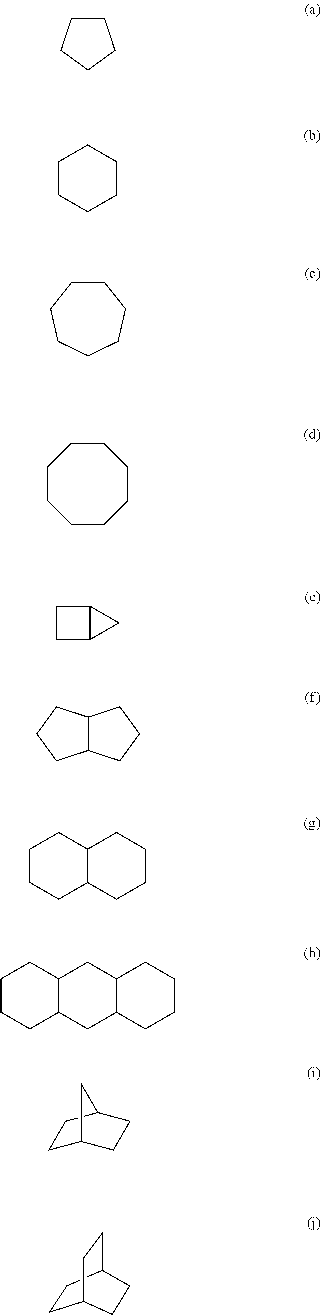

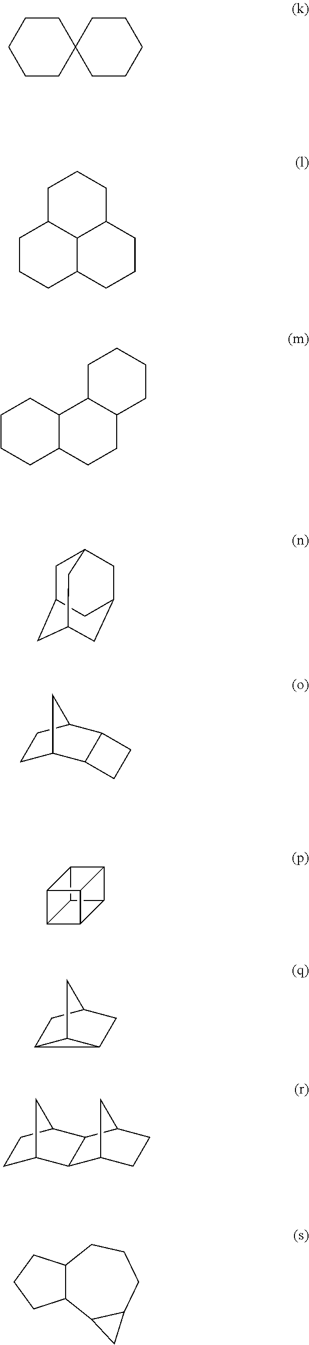

In Formula (2), examples of the C₁₋₂₀ alkyl group as Y¹, Y², Y³, and Y⁴ include a methyl group, an ethyl group, an isopropyl group, an n-pentyl group, and a cyclohexyl group.

Examples of the C₁₋₂₀ alkoxy group include a methoxy group, an ethoxy group, an isopropoxy group, an n-pentyloxy group, and a cyclohexyloxy group.

Examples of the halogen atom include a fluorine atom, a chlorine atom, a bromine atom, and an iodine atom.

As Y¹, Y², Y³, and Y⁴, a hydrogen atom and a C₁₋₂₀ alkyl group are preferred.

Particularly preferably, A¹ is a structure of Formula (4):

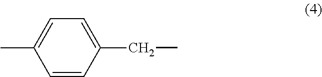

The hyperbranched polymer having a thioester group of the present invention has a weight average molecular weight Mw measured by gel permeation chromatography in terms of polystyrene of 500 to 5,000,000, preferably 1,000 to 1,000,000, more preferably 2,000 to 500,000, most preferably 3,000 to 200,000.

The hyperbranched polymer has a degree of distribution: Mw (weight average molecular weight)/Mn (number average molecular weight) of 1.0 to 7.0 or 1.1 to 6.0 or 1.2 to 5.0.

The hyperbranched polymer having a thioester group of the present invention can be obtained, for example, by reacting a hyperbranched polymer containing a dithiocarbamate group with a base such as an alkali metal alkoxide to convert the dithiocarbamate group to a thiol anion and subsequently reacting the thiol anion with an electrophile, that is, an electrophile of Ar¹ (CO) Z or Ar² (CO) Z (where Ar¹ and Ar² are the same as those defined in Formula (1), and Z is a halogen atom).

The hyperbranched polymer having a dithiocarbamate group can be produced by a method described in, for example, Koji Ishizu, Akihide Mori, Polymer International 50, 906-910 (2001), Koji Ishizu, Takeshi Shibuya, Akihide Mori, Polymer International 51, 424-428 (2002), and Koji Ishizu, Yoshihiro Ohta, Journal of Materials Science Letters, 22 (9), 647-650 (2003).

### Production Method of Varnish And Thin Film

The hyperbranched polymer containing a thioester group of the present invention can be made into a varnish form by dissolving or dispersing the hyperbranched polymer in a solvent.

Examples of the solvent used for the varnish form include tetrahydrofuran, methyltetrahydrofuran, 1,4-dioxane, diethylene glycol dimethyl ether, methyl ethyl ketone, cyclopentanone, cyclohexanone, ethyl acetate, cyclohexanol, 1,2-dichloroethane, chloroform, toluene, chlorobenzene, xylene, N,N-dimethylformamide, N,N-dimethylacetamide, dimethylsulfoxide, chlorobenzene, and propylene glycol methyl ether. These solvents may be used individually or in combination of two or more types thereof.

Although the concentration of the hyperbranched polymer dissolved or dispersed in the above-mentioned solvent is arbitrary, the concentration of the hyperbranched polymer is 0.001 to 90% by mass, preferably 0.002 to 80% by mass, more preferably 0.005 to 70% by mass, based on the total mass (the sum of masses) of the hyperbranched polymer and the solvent.

The prepared varnish is preferably filtered using a filter having a pore diameter of around 0.2 μm or the like to be used.

As a specific method for forming a thin film using the varnish of the present invention, first, the hyperbranched polymer containing a thioester group of the present invention is dissolved or dispersed in the above-mentioned solvent to be made into a varnish form (film forming material), and a substrate is coated with the varnish by a cast coating method, a spin coating method, a blade coating method, a dip coating method, a roll coating method, a bar coating method, a die coating method, an inkjet method, a printing method (letterpress-, engraved plate-, planographic-, screen-printing, and the like), or the like, followed by drying the varnish by a hot plate or an oven to form it into a film.

Among these coating methods, a spin coating method is preferred. When the spin coating method is used, the coating can be performed in a short time, so that there are such advantages as an advantage that even a highly volatile solution can be utilized as the varnish and an advantage that a highly homogeneous coating can be performed.

### Polymer Multilayer Film And Polymer Multilayer Film Mirror

A thin film formed from the hyperbranched polymer containing a thioester group of the present invention exhibits a high refractive index, so that by laminating the thin film with a polymer thin film having a refractive index different from that of the thin film by 0.05 or more, there can be expected various applications as an optical element to a polymer multilayer film, for example, a polymer multilayer film mirror, a polymer multilayer interference filter, a polymer multilayer polarization split film, a polymer multilayer anti-reflective coating, and the like.

Particularly, by alternately laminating a polymer thin film (high refractive index layer: H layer) having a quarter optical film thickness formed from the hyperbranched polymer of the present invention with a polymer thin film (low refractive index layer: L layer) having a quarter optical film thickness formed from a compound (such as cellulose acetate) having a refractive index relatively lower than that of the hyperbranched polymer in a plurality of times, a polymer multilayer film mirror capable of obtaining a high reflectance can be produced.

The polymer multilayer film mirror is produced, for example, by a method described in Patent Document 3, specifically by alternately laminating a high refractive index layer (H layer: a layer formed from the hyperbranched polymer of the present invention) and then a low refractive index layer (L layer) in this order in an odd number of times on a substrate such as an acrylic resin, a methacrylic resin, a polycarbonate resin, a polyolefin-based resin (particularly an amorphous polyolefin), a polyester-based resin, a polystyrene resin, an epoxy resin, and a glass. That is, the lamination is performed so that the layer in contact with the substrate and the most distant layer from the substrate become an H layer, and the number of laminations is ordinarily 11 layers or more, preferably 29 layers or more.

The L layer is not particularly limited so long as: the L layer is a layer having a refractive index lower than the refractive index of the thin film (H layer) formed from the hyperbranched polymer containing a thioester group of the present invention; the L layer is light transmissive relative to an incident light; and further, the L layer has a low light scattering property and a low light absorbing property. Examples of the material for the L layer include various polymer compounds described in Patent Document 3.

The H layer and the L layer are formed so that each of the layers has a quarter optical film thickness (λ/4) that is a thickness quarter the wavelength λ of the incident light. The film thicknesses of the H layer and the L layer are accordingly selected according to the individual refractive indexes of the used polymer materials, the wavelength (designed wavelength) of a light that is intended to be reflected, and the reflectance, and although the film thicknesses are not particularly limited, the film thicknesses are ordinarily around 0.05 μm to 0.5 μm or less.

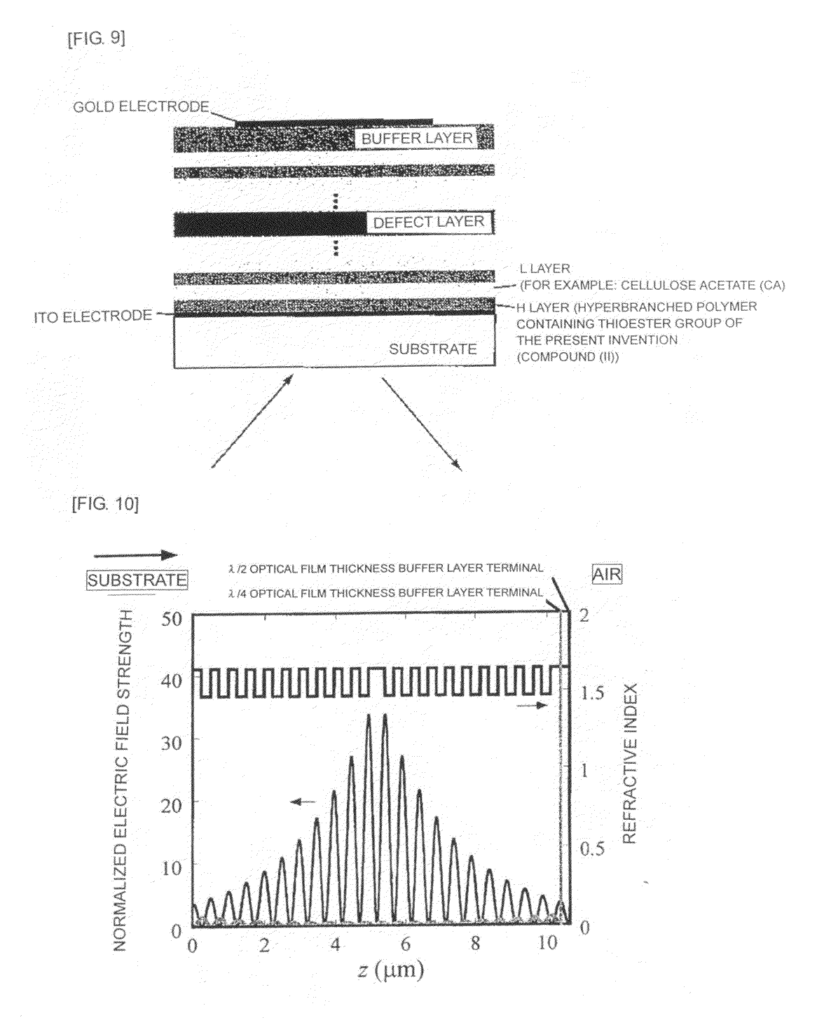

As another form of the above polymer multilayer film, there can be considered a structure in which the H layer and the L layer are alternately laminated in this order, and the H layer and the L layer are again alternately laminated, via a defect layer provided therebetween (see FIG. 9).

That is, by providing a defect layer in a one-dimensional periodic structure (photonic crystal: called 1D PC), optical electric fields can be localized in the defect layer (in the defect layer, the light strength becomes higher than the incident light strength). By preparing the defect layer with a nonlinear medium, for example, a second order nonlinear optical material, the increase of the nonlinear optical effect (generation of a second harmonic, electro-optic effect) utilizing the light localization becomes possible.

In this case, although for performing the poling treatment or the nonlinear optical effect evaluation, a gold electrode is necessary to be provided on the 1D PC upper part, a metal has a high reflectance and also absorbs light, so that the strength distribution in the 1D PC, that is, the localization strength in the defect layer becomes largely changed (according to a simulation by a transfer matrix method, by the presence of a gold electrode, the electric field strength in the defect layer results in a remarkable reduction). Therefore, as a method for preventing the reduction of the electric field strength, it can be considered to reduce the optical film thickness of the high refractive index layer (HPS-NP: layer formed from the hyperbranched polymer of the present invention) adjacent to the gold electrode to λ/2 as shown in FIG. 9 to prepare the high refractive index layer as a so-called “buffer layer”, or to remove the high refractive index layer. For example, in the case where a structure shown in FIG. 9 is constructed, when light enters perpendicularly, in the defect layer, the incidence electric field strength becomes about 36 times the incident light electric field strength at the maximum, about 4 times the incident light electric field strength as a spatial average value (see FIG. 10), so that an increase of the nonlinear optical effect corresponding to this increase becomes possible (Roussey, M., Bernal, M.-P., Courjal, N., Labeke, D. V. and Baida, F. I. and Salut, R, “Electro-optic effect exaltation on lithium niobate photonic crystals due to slow photons,” Appl. Phys. Lett. 89, 241110-1-3 (2006)).

### Functional Dye Dispersant

By using the hyperbranched polymer containing a thioester group of the present invention as a polymer matrix, a functional dye such as a fluorescent dye and a nonlinear optical dye can be dispersed.

Although the functional dye is not particularly limited so long as the functional dye dispersant of the present invention can disperse the functional dye, examples of the fluorescent dye include: compounds having a skeleton such as perylene, pyrene, anthracene, naphthalene, coumarin, oxazin, rhodamine, fluorescein, benzofurazan, quinacdorine, stilbene, luminol, phenothiazine, quinoline, and thiazole; and derivatives thereof.

Specific examples thereof include p-terphenyl, p-quaterphenyl, rhodamine 101, sulforhodamine 101, carbostyril 124, Cresyl Violet, 3,3′-diethyloxadicarbocyanine (DODC), coumarin 102, coumarin 120, coumarin 151, coumarin 152, coumarin 2, coumarin 314, coumarin 314T, coumarin 339, coumarin 30, coumarin 307, coumarin 343, coumarin 6, HIDC, DTPC, DOTC, HITC, DTTC, fluorescein, 2,7-dichlorofluorescein, Nile Blue A, rhodamine rhodamine 19, rhodamine B, sulforhodamine B, oxazin 4, and 4-(dicyanomethylene)-2-methyl-6-(p-(dimethylamino)styryl)-4H-pyran (DCM).

Examples of the nonlinear optical dye include, besides para-nitroaniline (p-NA), 4-dimethylamino-4′-nitrostilbene (DANS), 2-methyl-4-nitroaniline (MMA), 2-methoxy-5-nitrophenol (MNP), 4-[N-ethyl-N-(hydroxyethyl)]amino-4′-nitroazobenzene (DR1), 4-(N,N-bis(hydroxyethyl))amino-4′-nitroazobenzene (DR19), 4-(dicyanomethylene)-2-methyl-6-(p-(dimethylamino)styryl)-4H-pyran (DCM), 4-[(4-aminophenyl)azo]nitrobenzene (DO3), 3-methyl-4-nitropyridine-N-oxide (POM), 2-cyclooctylamino-5-nitropyridine (COANP), 4′-nitrobenzylidene-3-acetylamino-4-methoxyaniline (MNBA), 3,5-dimethyl-1-(4-nitrophenyl)pyrazole (DMNP), 4-(isopropoxycarbonyl)aminonitrobenzene (PCNB), and N-methoxymethyl-4-nitroaniline (MMNA), 2-(3-cyano-4-(4-((4-(ethyl(2-hydroxyethyl)amino)phenyl)diazenyl)styryl)-5,5-dimethylfuran-2(5H)-ylidene)malononitrile (AzTCF-OH), 2-(3-cyano-4-(4-((4-(bis(2-tert-butylcarbonyloxyethyl)amino)phenyl)diazenyl)styryl)-5,5-dimethylfuran-2(5H)-ylidene)malononitrile (AzTCF), and compounds of Formula (7):

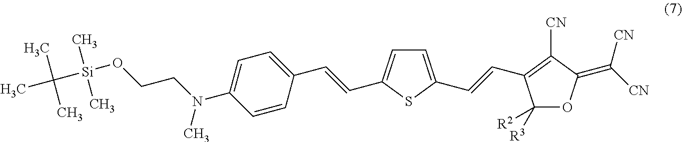

(where the combination of R² and R³ is R²:R³=methyl group:methyl group, trifluoromethyl group:methyl group, or trifluoromethyl group:phenyl group).

The blending amount of the functional dye in the hyperbranched polymer (polymer matrix) containing a thioester group of the present invention is preferably 0.0001 to 60% by mass, based on the total mass of the hyperbranched polymer of the present invention and the functional dye.

Particularly, when the functional dye is a fluorescent dye, the blending amount thereof is preferably 0.0001 to 20% by mass, more preferably 0.001 to 10% by mass.

When the functional dye is a nonlinear optical dye, the blending amount thereof is preferably 1 to 60% by mass, more preferably 10 to 40% by mass.

In the case where the blending amount of the functional dye is too small, when the hyperbranched polymer dispersion is used as a nonlinear optical material later, a satisfactory function of the dye may not be obtained. On the other hand, when the blending amount of the functional dye is too large, it is feared that film formation becomes difficult or the mechanical strength of the material is lowered.

### Nonlinear Optical Material

The nonlinear optical material produced by using the hyperbranched polymer containing a thioester group of the present invention as the polymer matrix and by dispersing the functional dye in the hyperbranched polymer is generally made into a form of a thin film to be used. The production method of the thin film is preferably a wet coating method including: dissolving a material containing the polymer matrix and the functional dye in an appropriate organic solvent to make the material a form of a coating liquid; and coating an appropriate substrate (for example, a silicon/silicon dioxide-coated substrate, a silicon nitride substrate, a substrate coated with a metal such as aluminum, molybdenum, and chromium, a glass substrate, a quartz substrate, and an ITO substrate) or a film (for example, resin films such as a triacetyl cellulose film, a polyester film, and an acrylic film) with the coating liquid by a spin coating, a flow coating, a roll coating, a slit coating, a slit coating followed by a spin coating, an inkjet coating, or a printing to form the coating liquid into a film.

Here, the solvent used for the preparation of the coating liquid is a solvent for dissolving the hyperbranched polymer of the present invention and the functional dye and for dissolving additives and the like blended if desired in the coating liquid that are described below, and the type and the structure of the solvent are not particularly limited so long as the solvent has the above dissolving ability. Examples of the solvent include the solvents exemplified in <Production method of varnish and thin film>.

The solid content in the coating liquid is, for example, 0.5 to 30% by mass or, for example, 5 to 30% by mass. The here called solid content means a mass remaining after subtracting the solvent from the coating liquid.

The prepared coating liquid is preferably filtered using a filter having a pore diameter of around 0.2 μm to be used.

In the coating liquid, if necessary, an antioxidant such as hydroquinone, an ultraviolet absorbent such as benzophenone, a rheology controlling agent such as a silicone oil and a surfactant, an adhesion assistant such as a silane coupling agent, a crosslinker for the polymer matrix, a compatibilizer, a curing agent, a pigment, a preservation stabilizer, an antifoamer, and the like may be blended.

Here, the nonlinear optical material (for example, thin film) produced using the mixed material of the hyperbranched polymer (polymer matrix) containing a thioester group of the present invention and the functional dye (nonlinear optical dye) is necessary to be subjected to poling treatment, for developing the nonlinear optical characteristics thereof. The poling treatment is an operation including: applying a predetermined electric field to the material in a state in which the material is heated to a temperature that is a glass transition temperature of the material or more and a melting point of the material or less; and cooling down the material while maintaining the electric field to orient molecules of the nonlinear optical dye. By this operation, the material can substantially develop the nonlinear optical characteristics.

Only by thinning the mixed material, the orientation of the molecules of the nonlinear optical dye contained in the mixed material is random, so that it is necessary to heat the mixed material to a temperature that is a glass transition temperature of the polymer compound as the matrix or more (when the polymer compound does not exhibit a glass transition temperature, about 120° C. or more) and a melting point of the polymer compound or less, and to subject the mixed material to poling treatment to develop the nonlinear optical characteristics thereof.

Here, when the nonlinear optical dye is a third order nonlinear optical dye, it is not necessary to orient the nonlinear optical dye by the poling treatment for developing the nonlinear optical characteristics, and only by a material in which the nonlinear optical dye is dispersed in a high concentration, the third order nonlinear optical characteristics can be developed.

### EXAMPLES

Hereinafter, the present invention will be described more in detail referring to Examples that should not be construed as limiting the scope of the present invention.

The measuring apparatuses and the like used in the present Examples are described below.

### Measuring Apparatus And the Like

[¹H NMR]
Apparatus: Lambda 600 (600 MHz); manufactured by JEOL Ltd.
Measuring solvent: CDCl₃
Standard substance: CHCl₃ (87.26 ppm)
[GPC (gel permeation chromatography)]
Apparatus: HLC-8220 GPC; manufactured by Tosoh Corporation
Column: Shodex (registered trade mark) KF-804L+KF-803L
Column temperature: 40° C.
Solvent: tetrahydrofuran
Detector: UV (254 nm), RI
Calibration curve: standard polystyrene
[Spin coater]
Apparatus: 1H-D7; manufactured by Mikasa Co., Ltd.
[Film thickness, refractive index]
Apparatus: multi incident angle spectroscopic ellipsometer VASE; manufactured by J.A. Woollam Japan Corp.
[Light ray transmittance, haze]
Apparatus: NDH-5000; manufactured by Nippon Denshoku Industries Co., Ltd.
[Glass transition point]
Apparatus: TG8120; manufactured by Rigaku Corporation
[Heat decomposition temperature]
Apparatus: DSC 8230; manufactured by Rigaku Corporation
[Ultraviolet-visible light spectrophotometer] V-670; manufactured by JASCO Corporation
[Differential interference microscope] ECLIPSE L150; manufactured by NIKON Corporation
[Stylus-type surface shape measuring apparatus] Dektak 3; manufactured by ULVAC, Inc.
[Magnetron sputtering apparatus] MPS-10; manufactured by Vacuum Device Inc.
[Heater] programmable precision bath pro-thermo bath NTB-221; manufactured by Tokyo Rikakikai Co., Ltd.
[High voltage power source apparatus] HEOPT-20B10-L1; manufactured by Matsusada Precision Inc.
[Function generator] WW5061; manufactured by TABOR ELECTRONICS Ltd.
[GPC-MALS]
Apparatus: DAWN HELEOS; Wyatt
Measuring temperature: 40° C.

### Reference Example 1

### Synthesis of Branched Polymer (HPS) Containing Dithiocarbamate Group

A branched polymer (HPS) of Formula (I) below was synthesized referring to a method described in Koji Ishizu, Akihide Mori, Macromol. Rapid Commun. 21, 665-668 (2000).

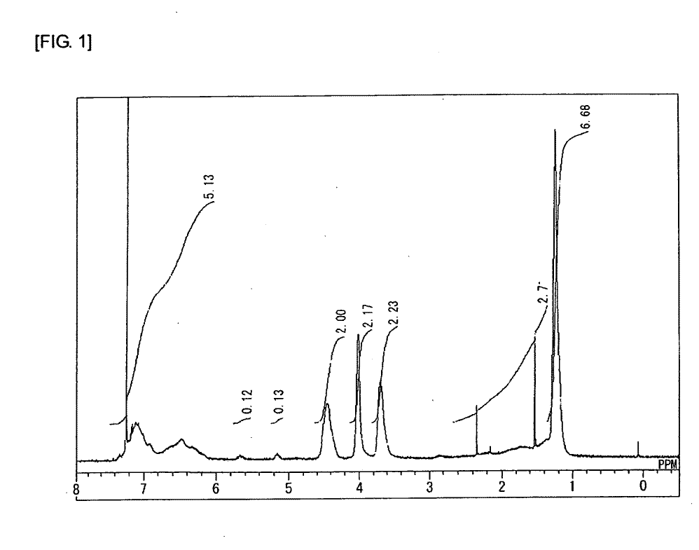

The weight average molecular weight Mw and the degree of distribution: Mw (weight average molecular weight)/Mn (number average molecular weight) measured by GPC in terms of polystyrene of the HPS were 20,000 and 3.4, respectively. ¹H NMR spectrum is shown in FIG. 1.

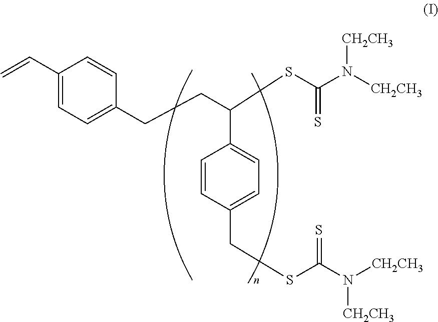

### Reference Examples 2 To 4

### Synthesis of Branched Polymer (HPS) Containing Dithiocarbamate Group

In the same manner as in Reference Example 1, HPSs of Formula (I) having weight average molecular weights Mw different from each other were synthesized.

The weight average molecular weight Mw and the degree of distribution: Mw (weight average molecular weight)/Mn (number average molecular weight) measured by GPC in terms of polystyrene of the obtained HPSs are shown in Table 1.

TABLE 1

| | | Degree of |
|---|---|---|
| | | distribution |
| Compound | Mw | Mw/Mn |
| Reference | 8,600 | 1.3 |
| Example 2 | | |
| Reference | 6,200 | 2.1 |
| Example 3 | | |
| Reference | 2,900 | 1.5 |
| Example 4 | | |

### Example 1

### Preparation of Hyperbranched Polymer Having 2-naphthoylthio Group

Into a 1 L three-neck flask equipped with a Dimroth cooling tube, 26.6 g of the HPS synthesized in Reference Example 1 and 10.5 g of potassium methoxide [manufactured by Aldrich Corp.] were charged, and the inside of the system was purged with nitrogen. Then, in a nitrogen stream, 500 mL of anhydrous tetrahydrofuran (THF) was added to the resultant reaction mixture to stir the reaction mixture at 20° C. until the reaction mixture became a homogeneous solution. After the dissolution of the HPS, further 100 mL of anhydrous acetonitrile was added to the reaction solution, and the resultant reaction mixture was stirred at 50° C. for 20 hours.

Next, into the reaction solution, while stirring the reaction solution at 50° C., a solution separately prepared by dissolving 38 g of 2-naphthoyl chloride [manufactured by Aldrich Corp.] in 200 mL of anhydrous THF in a nitrogen stream was dropped using a plunger pump at 2 mL/min. After the completion of the dropping, the reaction mixture was stirred at 50° C. further for 20 hours.

After the completion of the reaction, the reaction solution was cooled down to 20° C., and next thereto, 1.5 L of a 2-propanol/water=4/1 (volume ratio) mixed solution was added to subject the resultant reaction mixture to reprecipitation-purification. The resultant solid was filtered and dried under reduced pressure to obtain a yellow solid. The obtained solid was re-dissolved in 500 mL of THF, and the resultant solution was further subjected to reprecipitation-purification using 2 L of methanol, followed by filtering and drying the resultant solid under reduced pressure to obtain 28.6 g of a hyperbranched polymer of Formula (II) below having a 2-naphthoylthio group at a molecule terminal thereof as a white solid. Yield: 93%

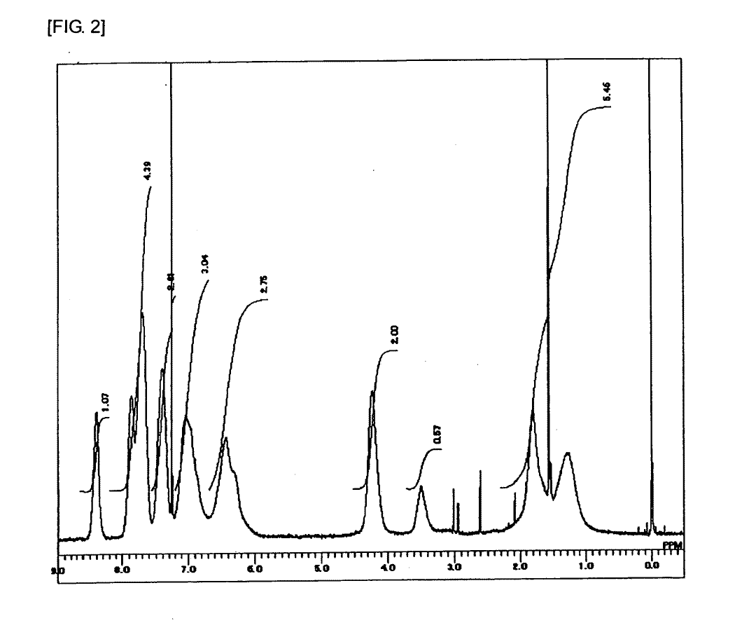

The weight average molecular weight Mw and the degree of distribution: Mw (weight average molecular weight)/Mn (number average molecular weight) measured by GPC in terms of polystyrene of the obtained HPS were 126,000 and 5.0 respectively. ¹H NMR spectrum is shown in FIG. 2.

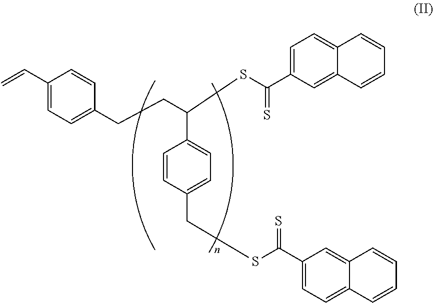

### Example 2

### Preparation of Hyperbranched Polymer Having 2-thenoylthio Group

Into a 200 mL three-neck flask equipped with a Dimroth cooling tube, 2.7 g of the HPS synthesized in Reference Example 1 and 1.1 g of potassium methoxide [manufactured by Aldrich Corp.] were charged, and the inside of the system was purged with nitrogen. Then, in a nitrogen stream, 56 mL of anhydrous tetrahydrofuran (THF) and 14 mL of anhydrous acetonitrile were added to the resultant reaction mixture to stir the reaction mixture at 20° C. until the reaction mixture became a homogeneous solution and further at 50° C. for 5 hours.

Next, into the reaction solution, while stirring the reaction mixture at 50° C., a solution separately prepared by dissolving 2.9 g of 2-thenoyl chloride [manufactured by Aldrich Corp.] in 24 mL of anhydrous THF and 6 mL of anhydrous acetonitrile in a nitrogen stream was dropped using a syringe. After the completion of the dropping, the reaction mixture was stirred at 50° C. further for 4 hours.

After the completion of the reaction, the reaction solution was cooled down to 20° C., and next thereto, 500 mL of a 2-propanol/water=4/1 (volume ratio) mixed solution was added to subject the resultant reaction mixture to reprecipitation-purification. The resultant solid was filtered and dried under reduced pressure to obtain 2.4 g of a hyperbranched polymer of Formula (III) below having a 2-thenoylthio group at a molecule terminal thereof as a white solid. Yield: 91%

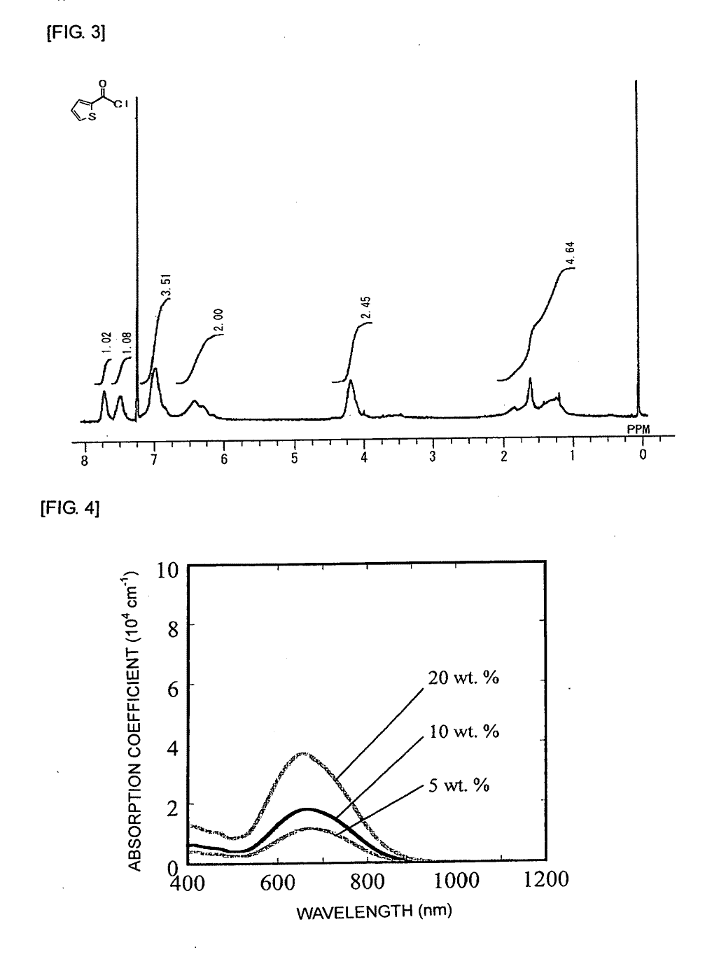

The weight average molecular weight Mw and the degree of distribution: Mw (weight average molecular weight)/Mn (number average molecular weight) measured by GPC in terms of polystyrene of the obtained HPS were 166,000 and 16.2, respectively. ¹H NMR spectrum is shown in FIG. 3.

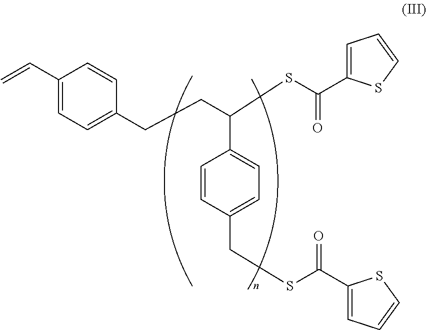

### Example 3

### Preparation of Thin Film And Evaluation of Characteristics

Each of the hyperbranched polymers obtained in Example 1, Example 2, and Reference Example 1 was dissolved in cyclohexanone to prepare a 1% by mass solution.

The solution was cast on a glass substrate through a filter having a pore diameter of 0.45 μm, and the glass substrate was coated with the solution by a spin coater (1,000 rpm×10 seconds, 3,000 rpm×30 seconds). Next, the solution on the substrate was dried by a hot plate of 150° C. for 30 minutes to obtain a transparent coating film.

The film thickness, the refractive index at 589 nm, the light ray transmittance, and the haze of the obtained coating film, and the glass transition point Tg and the heat decomposition temperature Td (5% weight loss temperature) of each compound are shown in Table 2.

TABLE 2

| | Film | Refractive | Light ray | | | |
|---|---|---|---|---|---|---|
| | thickness | index at | transmittance | | Tg | Td |
| Compound | (nm) | 589 nm | (%) | Haze | (° C.) | (° C.) |
| Example 1 | 250 | 1.72 | 95.8 | 0.22 | 96 | 329 |
| Example 2 | 124 | 1.68 | 98.3 | 0.05 | 89 | 305 |
| Reference | 266 | 1.66 | 97.2 | 0.56 | 56 | 257 |
| Example 1 | | | | | | |

As shown in Table 2, the thin films obtained from the hyperbranched polymers of Example 1 and Example 2 exhibited a higher refractive index and a lower haze value than those of the thin film obtained from the hyperbranched polymer of Reference Example 1, and exhibited a higher glass transition point and a higher heat decomposition temperature than those of the thin film obtained from the hyperbranched polymer of Reference Example 1. That is, there was obtained such a result that in the thin films obtained from the hyperbranched polymers of Example 1 and Example 2, transparency and heat resistance had been enhanced.

### Example 4

### Dispersing Characteristics of Nonlinear Dye FTC

To each of 5 mg, 10 mg, and 20 mg of a nonlinear dye FTC of Formula (IV) below, the compound (II) obtained in Example 1 was added so that each total amount became 100 mg (dye concentration in each solid content was 5, 10, 20% by mass), and each of the resultant mixtures was dissolved in cyclopentanone in an amount of a mass that was 19 times the mass of the compound (II). The resultant solution was filtered by a filter having a pore diameter of 0.2 μm, and then a glass substrate (Eagle 2000; manufactured by Corning Incorporated) was coated with the solution using a spin coater (1,000 rpm×10 seconds).

An absorption spectrum of the resultant thin film was measured using an ultraviolet-visible light spectrophotometer. By the film thickness value of the thin film obtained using a stylus-type surface shape measuring apparatus, the absorbance was converted into the absorption coefficient (absorption coefficient=absorbance/film thickness). The result is shown in FIG. 4.

As shown in the result in FIG. 4, an absorption spectrum in which the absorption coefficient was varied in proportion to a variation of the dye concentration was obtained, and a result indicating that the dye was homogeneously dispersed in the thin film without aggregation thereof was obtained.

Further, when the thin film was subjected to the Nomarski differential interference observation using a differential interference microscope, in any dye concentration, an aggregation region of the dye was not observed, and it was confirmed that there was obtained a thin film in which the dye was homogeneously dispersed without aggregation thereof, even at a high dye concentration.

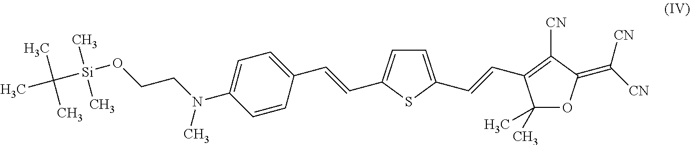

### Example 5

### Orientation By Poling Treatment

To 10 mg of FTC of Formula (IV), 90 mg of the compound (II) obtained in Example 1 was added (dye concentration in solid content was 10% by mass), and the resultant mixture was dissolved in 510 mg of cyclopentanone. The resultant solution was filtered by a filter having a pore diameter of 0.2 μm and was formed into a film on a glass substrate equipped with an ITO transparent electrode of which one edge was masked using a spin coater at a rotation number of 1,000 rpm for 100 seconds. The film thickness was measured by a stylus-type surface shape measuring apparatus and was 1 μm.

The mask was removed, and then the coated glass substrate was vacuum-dried at 80° C. On the resultant thin film, a gold upper electrode was provided using a magnetron sputtering apparatus in a thickness of 100 nm to prepare a test cell.

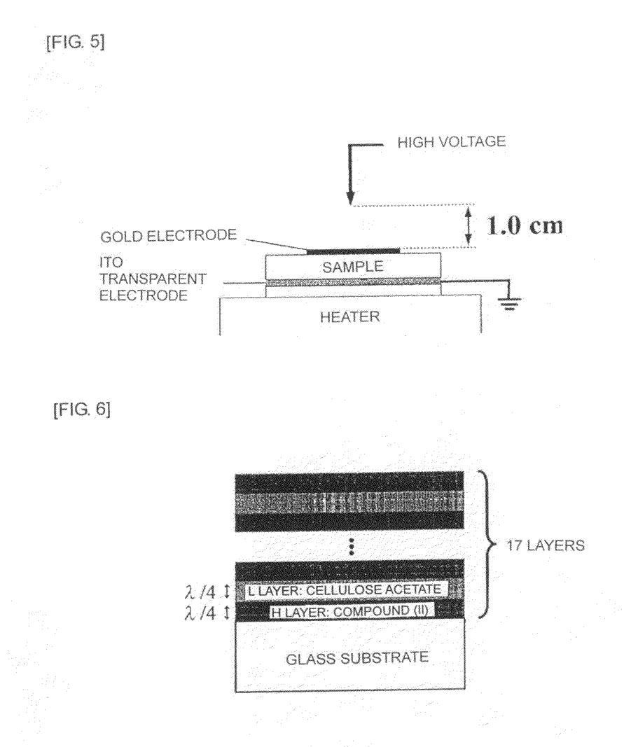

Next, as shown in FIG. 5, a corona needle (stainless steel-made) was distanced from the gold upper electrode of the test cell by a distance of 1 cm, and a discharge was performed using a high voltage power source apparatus and a function generator with a voltage of 4 kV for 30 minutes to subject the test cell to corona poling. At this time, the test cell was heated to 70° C. using a heater. After poling, the test cell was cooled down to room temperature, and the discharge was stopped to terminate the poling treatment.

When the electro-optic effect of the thin film subjected to the poling treatment was measured using a 1,310 nm semiconductor laser, the Pockels coefficient r₃₃ of the thin film was 17.2 pm/V. From this result, it was confirmed that a nonlinear optical dye contained in the thin film was oriented.

When the solubility of the dye of Formula (IV) in the compound (II) obtained in Example 1 and the solubility of the dye of Formula (IV) in polymethyl methacrylate (PMMA) conventionally used as a polymer matrix in the field of the organic nonlinear optical material are assumed to be the same as each other, and the refractive index change Δn (see the equation below) in the case where the compound (II) is used and the refractive index change Δn in the case where PMMA is used are compared, the refractive index change in the case where the compound (II) is used can be larger. That is, the compound (II) can be expected to be able to obtain larger electro-optic effect than PMMA.

Δn=(n³/2)r₃₃E_{z} (Δn: refractive index change, n: refractive index, r₃₃: Pockels coefficient, E_{z}: applied electric field)

### Example 6

### Preparation of Polymer Multilayer Film Mirror

The compound (II) as a polymer material for forming a high refractive index layer (H layer) and cellulose acetate (CA: manufactured by Aldrich Corp., catalog No. 180955) as a polymer for forming a low refractive index layer (L layer) were used, and by alternately repeating a set of the spin coating of a glass substrate (Eagle 2000; manufactured by Corning Incorporated; refractive index at 1,530 nm: 1.493) or of the L layer with a preliminarily prepared solution of the compound (II) and the drying of the solution, and a set of the spin coating of the H layer with a preliminarily prepared solution of cellulose acetate and the drying of the solution, under the conditions shown in Table 3, 17 layers (H layer: 9 layers, L layer: 8 layers) were laminated on the glass substrate to prepare a polymer multilayer film mirror in which the H layer and the L layer were alternately laminated (FIG. 6). Here, the conditions shown in Table 3 were set so that the film thickness of each layer became λ/4 (λ: designed wavelength 1,530 nm), that is, 383 nm.

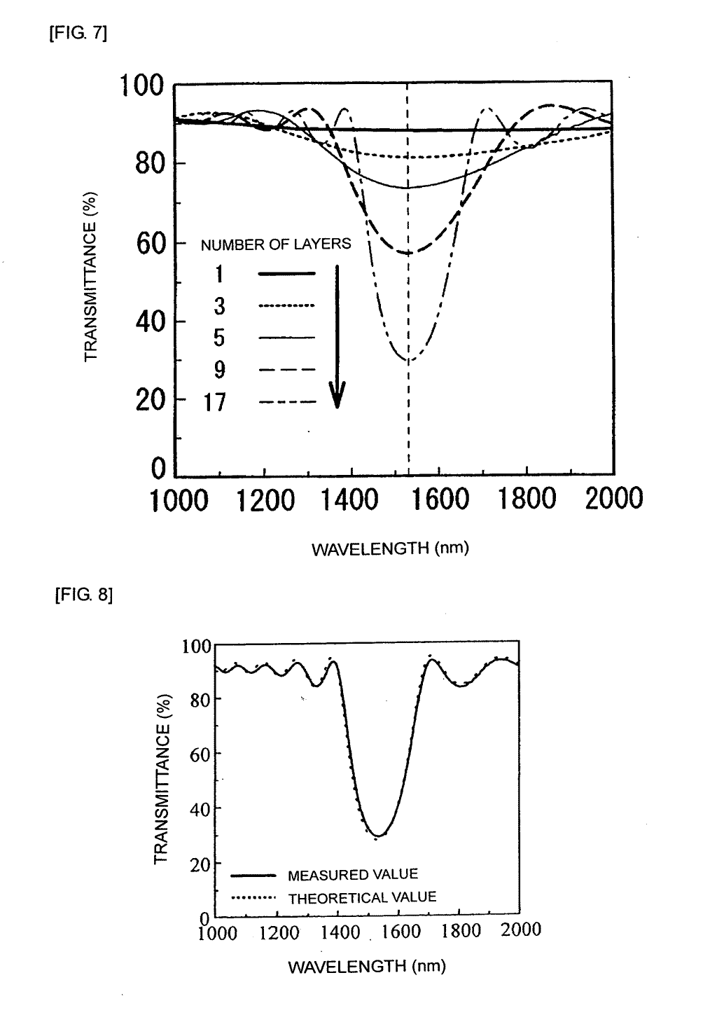

When the transmission spectrum of the polymer multilayer film mirror was measured using an ultraviolet-visible light spectrophotometer and was compared with the theoretical curve calculated by a transfer matrix method, the curve of the transmission spectrum agreed substantially with the theoretical curve. The variation of the spectrum according to the number of laminated layers is shown in FIG. 7, and the comparison with the theoretical value is shown in FIG. 8.

That is, it was confirmed that even when increasing the number of laminated layers, the permeation of light to an already-provided underlayer film (accomplished layer) and the film loss were not caused, and the polymer multilayer film mirror was produced corresponding to the designing.

TABLE 3

| | | | H layer | L layer |
|---|---|---|---|---|
| Solution | Polymer material | | Compound (II) | Cellulose acetate |
| | Solvent | | Chlorobenzene | Diacetone alcohol |
| | Concentration (g/L) | | 70 | 45 |
| Spin | Number of | Coating on | 3,050 rpm | |
| Coating | rotations | substrate | | |
| | | Coating on | 3,200 rpm | |
| | | L layer | | |
| | | Coating on | | 2,700 rpm |
| | | H layer | | |

| | | |
|---|---|---|
| Time (second) | 60 | 100 |

| | | |
|---|---|---|
| Drying | Temperature (° C.) | 120 |
| | Time (minute) | 10 |

### Example 7

### Preparation of Hyperbranched Polymer Having 2-naphthoylthio Group

Into a 200 mL three-neck flask equipped with a Dimroth cooling tube, 2.7 g of the HPS synthesized in Reference Example 2 and 1.1 g of potassium methoxide [manufactured by Aldrich Corp.] were charged, and the inside of the system was purged with nitrogen. Then, in a nitrogen stream, 56 mL of anhydrous tetrahydrofuran (THF) and 14 mL of anhydrous acetonitrile were added to the resultant reaction mixture to stir the reaction mixture at 20° C. until the reaction mixture became a homogeneous solution, followed by stirring the resultant reaction solution at 50° C. further for 16 hours. Next, into the reaction solution, while stirring the reaction solution at 50° C., a solution separately prepared by dissolving 3.8 g of 2-naphthoyl chloride [manufactured by Aldrich Corp.] in 24 mL of anhydrous THF and 6 mL of anhydrous acetonitrile in a nitrogen stream was dropped using a syringe. After the completion of the dropping, the resultant reaction mixture was stirred at 50° C. further for 16 hours.

After the completion of the reaction, the reaction solution was cooled down to 20° C., and next added to 300 mL of a 2-propanol/water=4/1 (volume ratio) mixed solution to subject the resultant reaction mixture to reprecipitation-purification. The resultant solid was filtered and dried under reduced pressure to obtain 2.5 g of a hyperbranched polymer of Formula (II) having a 2-naphthoylthio group at a molecule terminal thereof as a white solid. Yield: 81%

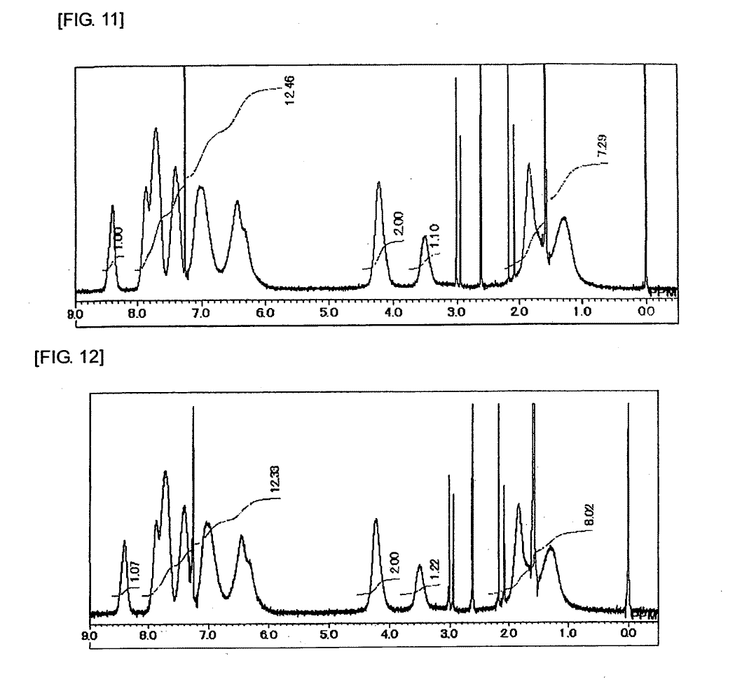

The weight average molecular weight Mw and the degree of distribution: Mw (weight average molecular weight)/Mn (number average molecular weight) measured by GPC in terms of polystyrene of the obtained HPS were 52,000 and 6.4, respectively. ¹H NMR spectrum is shown in FIG. 11.

### Example 8

### Preparation of Hyperbranched Polymer Having 2-naphthoylthio Group

By the same operation as in Example 7, except that instead of the HPS synthesized in Reference Example 2, the HPS synthesized in Reference Example 3 was used, 2.5 g of a hyperbranched polymer of Formula (II) having a 2-naphthoylthio group at a molecule terminal thereof was obtained as a white solid. Yield: 81%

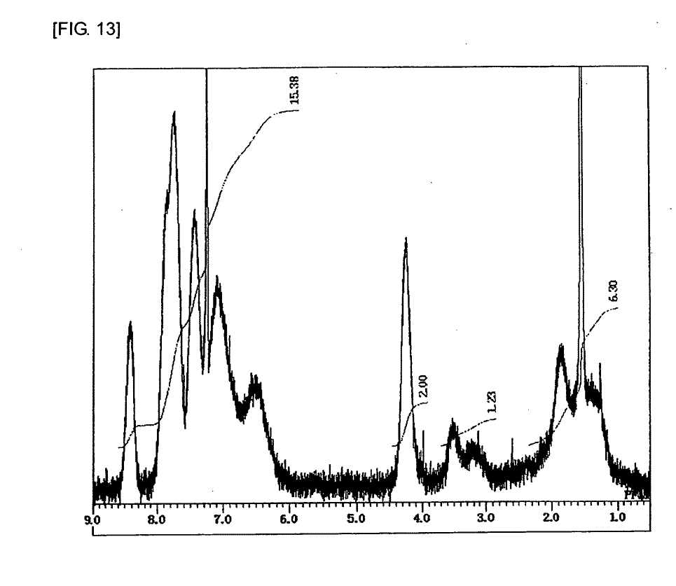

The weight average molecular weight Mw and the degree of distribution: Mw (weight average molecular weight)/Mn (number average molecular weight) measured by GPC in terms of polystyrene of the obtained HPS were 35,000 and 4.4, respectively. ¹H NMR spectrum is shown in FIG. 12.

The weight average absolute molecular weight Mw_{G} measured by GPC-MALS was 73,000, and the branching degree: Mw_{G} (weight average absolute molecular weight)/Mw (weight average molecular weight) that is an index indicating the degree of branching was 2.1.

### Example 9

### Preparation of Hyperbranched Polymer Having 2-naphthoylthio Group

By the same operation as in Example 7, except that instead of the HPS synthesized in Reference Example 2, the HPS synthesized in Reference Example 4 was used, 1.3 g of a hyperbranched polymer of Formula (II) having a 2-naphthoylthio group at a molecule terminal thereof was obtained as a light yellow solid. Yield: 42%

The weight average molecular weight Mw and the degree of distribution: Mw (weight average molecular weight)/Mn (number average molecular weight) measured by GPC in terms of polystyrene of the obtained HPS were 8,000 and 2.5, respectively. ¹H NMR spectrum is shown in FIG. 13.

The weight average absolute molecular weight Mw_{G} measured by GPC-MALS was 26,000, and the branching degree: Mw_{G} (weight average absolute molecular weight)/Mw (weight average molecular weight) that is an index indicating the degree of branching was 3.3.

### Example 10

### Preparation of Hyperbranched Polymer Having 2-thenoyithio Group

By the same operation as in Example 9, except that instead of 3.8 g of 2-naphthoyl chloride, 2.9 g of 2-thenoyl chloride [manufactured by Aldrich Corp.] was used, 1.8 g of a hyperbranched polymer of Formula (III) having a 2-thenoylthio group at a molecule terminal thereof was obtained as a light yellow solid. Yield: 69%

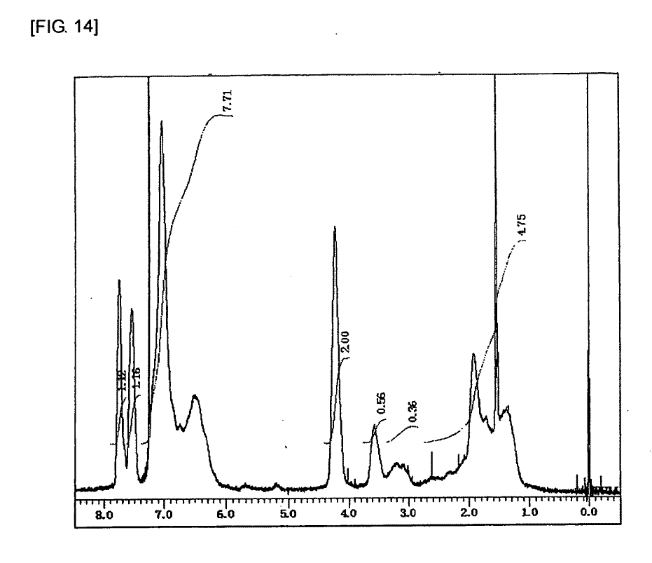

The weight average molecular weight Mw and the degree of distribution: Mw (weight average molecular weight)/Mn (number average molecular weight) measured by GPC in terms of polystyrene of the obtained HPS were 7,900 and 2.6, respectively. ¹H NMR spectrum is shown in FIG. 14.

### Example 11

### Preparation of Thin Film

Each of the compounds obtained in Example 7 and Example 8 was dissolved in cyclohexanone to prepare a 1% by mass solution.

The solution was cast on a glass substrate through a filter having a pore diameter of 0.45 μm, and the glass substrate was coated with the solution using a spin coater (3,000 rpm×30 seconds). Next, the solution on the substrate was dried by a hot plate of 150° C. for 30 minutes to obtain a transparent coating film.

The film thickness, the refractive index at 589 nm, the light ray transmittance, and the haze of the obtained coating film, and the heat decomposition temperature Td (5% weight loss temperature) of each compound are shown in Table 4.

### Example 12

### Preparation of Thin Film

By subjecting each of the compounds obtained in Example 9 and Example 10 to the same operation as in Example 11, except that the condition for spin coating (1,000 rpm×10 seconds, 3,000 rpm×30 seconds) was changed, each transparent coating film was obtained.

The film thickness, the refractive index at 589 nm, the light ray transmittance, and the haze of the obtained coating film, and the heat decomposition temperature Td (5% weight loss temperature) of each compound are summarized in Table 4.

TABLE 4

| | Film | Refractive | Light ray | | |
|---|---|---|---|---|---|
| | thickness | index at | transmittance | | Td |
| Compound | (nm) | 589 nm | (%) | Haze | (° C.) |
| Example 7 | 80 | 1.71 | 99.9 | 0.16 | 337 |
| Example 8 | 82 | 1.71 | 99.9 | 0.24 | 330 |
| Example 9 | 324 | 1.71 | 98.5 | 0.07 | 328 |
| Example 10 | 286 | 1.70 | 97.5 | 0.38 | 280 |

1. A hyperbranched polymer containing a thioester group of Formula (1): 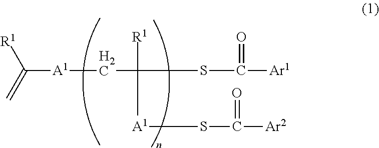
[where R¹ is a hydrogen atom or a methyl group;
Ar¹ and Ar² are independently an aromatic ring group constituted of 5 to 18 ring atoms that is optionally substituted with a C₁₋₆ alkyl group, a C₁₋₆ alkoxy group, a C₁₋₆ alkylthio group, or a halogen atom;
A¹ is a structure of Formula (2) or Formula (3) below; and
n is the number of repeating unit structures and is an integer of 2 to 100,000]: 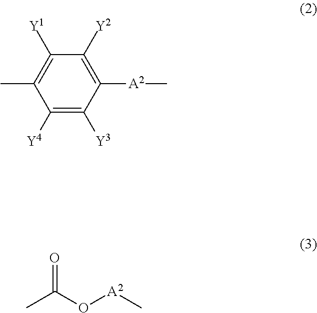
[in Formula (2) and Formula (3), A² is a linear C₁₋₃₀ alkylene group that optionally contains an ether bond or an ester bond, or a branched or cyclic C₃₋₃₀ alkylene group that optionally contains an ether bond or an ester bond; and
Y¹, Y², Y³, and Y⁴ are independently a hydrogen atom, a C₁₋₂₀ alkyl group, a C₁₋₂₀ alkoxy group, a halogen atom, a nitro group, a hydroxy group, an amino group, a carboxy group, or a cyano group].

2. The hyperbranched polymer containing a thioester group according to claim 1, wherein A¹ is a structure of Formula (4):

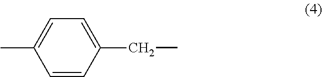

3. The hyperbranched polymer containing a thioester group according to claim 1 wherein at least one of Ar¹ and Ar² is a structure of Formula (5): 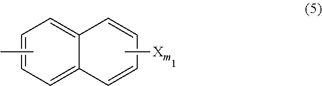
[where X is a C₁₋₆ alkyl group, a C₁₋₆ alkylthio group, or a halogen atom; and
m₁ is the number of added Xs and is an integer of 0 to 7].

4. The hyperbranched polymer containing a thioester group according to claim 1 wherein at least one of Ar¹ and Ar² is a structure of Formula (6): 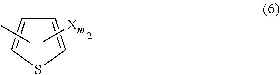
[where X is a C₁₋₆ alkyl group, a C₁₋₆ alkylthio group, or a halogen atom; and
m₂ is the number of added Xs and is an integer of 0 to 3].

5. A varnish produced by dissolving or dispersing the hyperbranched polymer containing a thioester group as claimed in claim 1 in at least one type of solvent.

6. A thin film produced from the varnish as claimed in claim 5.

7. A polymer multilayer film produced by using the thin film as claimed in claim 6.

8. A polymer multilayer film mirror produced by alternately laminating a high refractive index film containing the thin film as claimed in claim 6 and a low refractive index film having a refractive index lower than a refractive index of the high refractive index film on a substrate.

9. A functional dye dispersant comprising the hyperbranched polymer containing a thioester group as claimed in claim 1.

10. A nonlinear optical material produced by dispersing a functional dye in the hyperbranched polymer containing a thioester group as claimed in claim 1.

11. The hyperbranched polymer containing a thioester group according to claim 2, wherein at least one of Ar¹ and Ar² is a structure of Formula (5): 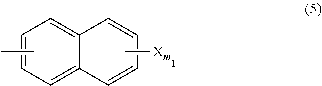
[where X is a C₁₋₆ alkyl group, a C₁₋₆ alkylthio group, or a halogen atom; and
m₁ is the number of added Xs and is an integer of 0 to 7].

12. A varnish produced by dissolving or dispersing the hyperbranched polymer containing a thioester group as claimed in claim 2 in at least one type of solvent.

13. A varnish produced by dissolving or dispersing the hyperbranched polymer containing a thioester group as claimed in claim 3 in at least one type of solvent.

14. A varnish produced by dissolving or dispersing the hyperbranched polymer containing a thioester group as claimed in claim 4 in at least one type of solvent.

15. A functional dye dispersant comprising the hyperbranched polymer containing a thioester group as claimed in claim 2.

16. A functional dye dispersant comprising the hyperbranched polymer containing a thioester group as claimed in claim 3.

17. A functional dye dispersant comprising the hyperbranched polymer containing a thioester group as claimed in claim 4.

18. A nonlinear optical material produced by dispersing a functional dye in the hyperbranched polymer containing a thioester group as claimed in claim 2.

19. A nonlinear optical material produced by dispersing a functional dye in the hyperbranched polymer containing a thioester group as claimed in claim 3.

20. A nonlinear optical material produced by dispersing a functional dye in the hyperbranched polymer containing a thioester group as claimed in claim 4.

21. The hyperbranched polymer containing a thioester group according to claim 2 wherein at least one of Ar¹ and Ar² is a structure of Formula (6): 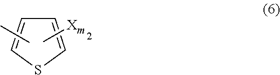
[where X is a C₁₋₆ alkyl group, a C₁₋₆ alkylthio group, or a halogen atom; and
m₂ is the number of added Xs and is an integer of 0 to 3].
